(19) United States
(12) Patent Application Publication
(10) Pub. No.: US 2010/0176992 A1
(43) Pub. Date: Jul. 15, 2010

(54) METHOD AND DEVICE FOR DETERMINING A POSITION

(76) Inventor: Stephen T'siobbel, Merelbeke (BE)

Correspondence Address: HARNESS, DICKEY & PIERCE, P.L.C., P.O. BOX 8910, RESTON, VA, 20195, US

(21) Appl. No.: 12/452,732

(22) PCT Filed: Jul. 31, 2008
(86) PCT No.: PCT/EP2008/060091

§ 371 Date: Mar. 17, 2010

(30) Foreign Application Priority Data
Jul. 31, 2007 (NL) PCT/NL2007/050383

(51) Int. Cl. G01S 19/42

(52) U.S. Cl. 342/357.25

(57) ABSTRACT

A positioning device is disclosed including a receiving device to receive signals from a plurality of transmitters, the transmitters being part of an absolute positioning system. In at least one embodiment, the position device is further arranged to determine transmitter positions of each transmitter and to compute from which transmitters direct receipt of signals is possible based on a previously determined position, the respective transmitter positions and multi path information. The positioning device is further arranged to determine a position. A method, computer program, and data carrier are further disclosed.

### TECHNICAL FIELD

The present invention relates to a method for determining a position, a positioning device, a computer program, a data carrier and a digital map database.

### BACKGROUND

The global positioning system (GPS-system) is used worldwide by users to determine their position (longitude, latitude, altitude) on earth.

The GPS-system comprises a number of satellites orbiting the earth, each satellite transmitting radio signals comprising precise timing information about the time the radio signals are transmitted by the satellite. The radio signals also comprise (orbital) information about the satellite position (or transmitter position) of the respective satellite, and a satellite identification that is unique for a specific satellite.

Positioning devices, such as GPS-receivers, are arranged to receive these signals and compute their position based on the received signals.

Positioning devices are arranged to receive these transmitted radio signals and compute the travel time of such a radio signal. The travel time is usually 65-85 milliseconds. Based on the travel time, the distance of the positioning device to the satellite can be computed, simply by multiplying the travel time with the speed of light (c=299.792.458 m/s).

Based on the received orbital information comprised by the radio signal, the positioning device can compute the position of the satellite. By combining the information of the distance to the satellite and the position of the satellite, the positioning device is placed on an imaginary sphere whose radius equals the distance and whose centre is the satellite.

By repeating this computation process for a number of satellites, the positioning device can compute the position of the positioning device. To do so, three satellites are needed for computing a spatial position and a fourth satellite is needed to synchronize the clocks. Of course, more satellites may be used to increase the accuracy.

It will be understood that also other positioning systems using satellites are used or being developed. These positioning systems will here be referred to as absolute positioning systems. Such absolute positioning system may be any kind of satellite based positioning system or global navigation satellite system (GNSS), such as the GPS-system, the European Galileo system, the Russian GLONASS, the Japanese QSSZ and the Chinese BNS.

Positioning devices are often used in or as navigation devices comprising digital map data. Such navigation devices may be arranged to show the position as determined on the digital map using a display. Such a navigation device may be referred to as a map displaying device, where the part of the displayed map is determined by the actual position as determined by the positioning device using the absolute positioning system.

Also, such navigation devices may be arranged to compute navigation instructions from a start position (for instance the current position) to a destination position, to guide the user to the destination address. Since the positioning device is able to position the current position on the digital map, the navigation device is capable of providing detailed navigation instructions, such as: “after 100 metres, turn left”. It will be understood that accurate positional information is needed for such applications in order to ensure optimal navigation and optimal user comfort.

In order to increase the accuracy of the position as determined by the positioning device using the absolute positioning system, the positioning device may use more satellites. Generally, a positioning device use s information from all satellites from which it receives radio signals. The more satellites are used, the more accurate the determined position.

The accuracy of the position as determined by the positioning device using the absolute positioning system is influenced by a number of factors, such as the computed position of the satellite, the computed travel time of the radio signal etc. A number of techniques are known to decrease the effect of system errors. However, also a number of further outside errors can be identified reducing the accuracy of the determined position, such as ionospheric effects, errors of the satellite clocks etc. One special type of error is so-called multi-path distortion.

Multi-path may occur in situations in which the radio signal as transmitted by a satellite is first reflected by an object, such as a building before reaching the positioning device. Therefore, the positioning device may receive one or more versions of the same radio signal, possibly including a direct signal (i.e. not reflected). In fact, reflections may come off several buildings or part of the same building all with different paths. As a result, the computed distance between the satellite and the positioning device may be incorrect, resulting in an error in the computed position of the positioning device.

According to the prior art, the problem of multi-path distortion was addressed by investigating (1) the characteristics of the satellite signal itself (signal to noise ratios), (2) the design and placement of antennas, and (3) use of dedicated filters.

It is an object to provide an alternative solution to the multi-path distortion problem.

### SUMMARY

There is provided a method for determining a position, the method comprising:
receiving signals from a plurality of transmitters, the transmitters being part of an absolute positioning system,
determining transmitter positions of each transmitter,
computing from which transmitters direct receipt of signals is possible based on a previously determined position, the respective transmitter positions and multi path information, and
determining a position. By using available multi path information, it can be determined from which transmitters direct receipt of signals is possible and from which transmitters no direct is possible. This makes it possible to determine a position only using direct received signals, resulting in a more accurate determined position.

According to an embodiment the transmitter positions are determined based on information comprised by the signals, or by retrieving transmitter positions from a memory.

According to an embodiment the multi path information is stored in a digital map database. This is a easy and effective way to provide multi path information.

According to an embodiment the digital map database is a three dimensional digital map database. Multi path information may easily be deduced from such a three dimensional digital map database.

According to an embodiment the three dimensional map database comprises multi path information in the form of three dimensional objects such as buildings, trees, rocks, mountains etc.

According to an embodiment multi path information is provided by one of:
height information of an object, and distance of that object with respect to the road,
elevation angle α′ for a certain location or road,
combination of elevation angle α′ and direction angle β′ for a certain position,
environmental factors like tree coverage,
a set of elevation angles α′ and direction angles β′, or heights of buildings along the road and the location of the façade with respect to the road.

According to an embodiment the multi path information is determined on the fly using a sensor. This provides up to date multi path information, including moving objects, as trucks and the like.

According to an embodiment the sensor may be one of a camera, fisheye camera, laser scanner.

According to an embodiment the previous position is a predicted position.

According to an embodiment the previous position is obtained from another positioning source. This may for instance be a relative positioning system.

According to an embodiment the method further comprises:
computing the position based on the signals received from transmitters of which direct receipt is possible.

According to an embodiment the actions of
computing from which transmitters direct receipt of signals is possible based on a previously determined position, the respective transmitter positions and multi path information, and
computing the position based on the signals received from transmitters of which direct receipt is possible,

are repeatedly performed in an iterative process to determine a position.

According to an embodiment the position may be determined in
a first mode, in which the position is determined using the absolute positioning system and possibly a relative positioning system, and in
a second mode, in which the position is determined using the relative positioning system and possibly the absolute positioning system, and

in the first mode the absolute positioning system being weighted more heavily than in the second mode, the method further comprising
determining the number of transmitters from which direct receipt of signals is possible and
switching from first mode to the second mode in case the number of transmitters is below a predetermined threshold.

According to an embodiment the method further comprises switching from the second mode to the first mode in case the number of transmitters is above a predetermined threshold.

According to an embodiment the position is determined by weighed combination of an absolute positioning system and a relative positioning system using weighing factors, the method further comprising
determining the number of transmitters from which direct receipt of signals is possible and
adjusting the weighing factors based on the number of transmitters from which direct receipt of signals is possible.

According to an embodiment computing from which transmitters direct receipt of signals is possible comprises using the multi path information to determine an elevation angle (α) and a direction (β) of each respective transmitter with respect to the previously determined position.

According to an embodiment computing from which transmitters direct receipt of signals is possible further comprises computing if a line connecting the position device and a respective transmitter intersects an obstruction comprised by the multi path information.

According to an embodiment the plurality of transmitters are satellites being part of a global navigation satellite system.

According to an embodiment a margin is used with respect to the multi path information to ensure that a clearance is provided between the multi path information and the line of sight connecting the positioning device and the transmitter. Such a margin takes into account inaccuracies in the height of buildings, previous determined position etc.

There is provided a positioning device comprising:
a receiving device to receive signals from a plurality of transmitters, the transmitters being part of an absolute positioning system,

the positioning device being arranged to determine transmitter positions of each transmitter and to compute from which transmitters direct receipt of signals is possible based on a previously determined position, the respective transmitter positions and multi path information and the positioning device is further arranged to determine a position.

There is provided a computer program, when loaded on a computer arrangement, is arranged to perform any one of the methods as described above.

There is provided a data carrier, comprising a computer program according to the above.

There is provided a digital map database comprising multi path information.

According to an embodiment the multi path information is at least one of:
height information of an object, and distance of that object with respect to the road,
elevation angle α for a certain location or road,
combination of elevation angle α and direction angle β for a certain position,
environmental factors like tree coverage.

### BRIEF DESCRIPTION OF THE DRAWINGS

The present invention will now be discussed in more detail using a number of exemplary embodiments, with reference to the drawings, which are only intended to illustrate the present invention and not to limit its scope which is only limited by the appended claims:

FIG. 1 schematically depicts a positioning device positioned in the real-world according to the prior art,

FIG. 2 schematically depicts a positioning device according to an embodiment,

FIG. 3 schematically depicts a three dimensional map database as may be used by a positioning device according to an embodiment,

FIG. 4 schematically depicts a positioning device positioned in the real world,

FIG. 5 schematically depicts a flow diagram according to an embodiment,

FIG. 6 schematically depicts a positioning device according to an embodiment,

FIG. 7 schematically depicts a flow diagram according to embodiment,

FIGS. 8a and 8b schematically depict a further embodiment, and

FIGS. 9a and 9b schematically depict a further embodiment.

### DETAILED DESCRIPTION

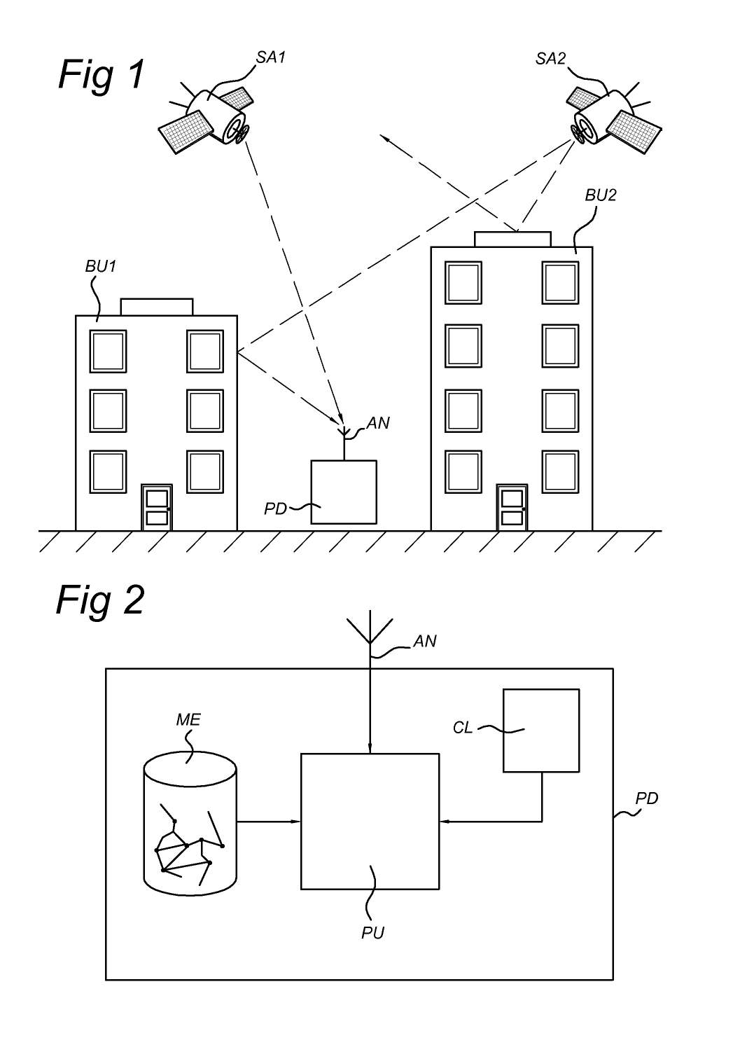

FIG. 1 shows a positioning device PD as already described above. The positioning device PD will be explained in further detail below with reference to FIG. 2. The positioning device PD comprises a receiving device, such as an antenna AN. The receiving device is arranged to receive radio signals transmitted by satellites SA1, SA2 and transmit these received radio signals to the positioning device PD. Although the receiving device is depicted as an antenna AN extending from the positioning device PD, it will be understood that the receiving device may also be situated inside the positioning device PD. According to an embodiment, also a clock CL may be provided to provide accurate time information.

As already described above, the positioning device PD may be arranged to receive radio signals from satellites SA1, SA2 via antenna AN. From these radio signals, the position of the positioning device PD can be computed as will be understood by a skilled person.

FIG. 1 further shows that the positioning device PD is positioned in between a first building BU1 and a second building BU2.

FIG. 1 further schematically shows a first satellite SA1 and a second satellite SA2 orbiting the earth. It will be understood that although only two satellites SA1, SA2 are shown in FIG. 1 in fact, more than two satellites SA1, SA2 will usually be present.

The first satellite SA1 transmits radio signals, indicated with the dotted line. It can be seen that the radio signals can be detected by the positioning device PD. The positioning device PD can now compute the distance from the positioning device PD to the first satellite SA1.

The second satellite SA2 also transmits radio signals, also indicated with the dotted line. However, these radio signals can not travel to the antenna AN of the positioning device PD directly, since second building BU2 blocks direct receipt of the radio signals. The radio signals can only reach the antenna AN of the positioning device PD indirectly after being reflected by the first building BU1.

It will be understood that the figures just show a possible example of multi-path and that in fact many other situations can occur. The radio signals can reflect via one or more buildings and/or the ground before reaching the positioning device PD. The positioning device PD may receive more versions of the same radio signal, all reaching the positioning device PD via different routes.

Multi-path errors will lead to an erroneous determined position of the positioning device PD, even when used in combination with information obtained from a plurality of satellites SA1, SA2.

Satellite signals for positioning are very weak and when picked up by a positioning device PD they might have bounced against a wall or other object leading to a wrong distance measurement and subsequent wrong position in space (the multi-path effect). This multi-path problem is an important contributor to the overall position error in satellite based navigation systems. Mitigating or avoiding this multi-path effect can lead to more accurate positioning.

Positioning Device

The positioning device PD is shown in more detail in FIG. 2. The positioning device PD is only shown schematically, but it will be understood that the positioning device PD may be formed as a computer unit, for instance comprising a processor or processor unit PU for performing arithmetical operations and a memory ME. The processor PU may have access to the memory ME, the memory ME comprising programming lines readable and executable by the processor PU to provide the positioning device PD with the functionality described here. The memory ME may further comprise a digital map database DMD as explained below.

The memory ME may be a tape unit, hard disk, a Read Only Memory (ROM), Electrically Erasable Programmable Read Only Memory (EEPROM) and a Random Access Memory (RAM).

The processing unit PU may further comprise or be arranged to communicate with
input devices, such as a keyboard, a mouse, a touch screen, a microphone,
output devices, such as a display, a printer, a speaker,
reading devices to read data carriers, such as for instance floppy disks, CD ROM's, DVD's FLASH cards, USB-sticks and the like and
communication devices arranged to communicate with other computer systems via a communication network, such as via a mobile telephone network, a GSM-network, a UMTS-network, a RF-network, (wireless) Internet etc.

However, it should be understood that there may be provided more and/or other memory, input devices, output devices and read devices known to persons skilled in the art. Moreover, one or more of them may be physically located remote from the processor unit PU, if required. The processor unit PU is shown as one box, however, it may comprise several processor units functioning in parallel or controlled by one main processor unit that may be located remote from one another, as is known to persons skilled in the art.

The positioning device PD may further comprise or be arranged to communicate with the clock CL and the antenna AN. The clock CL may be used in combination with the absolute positioning system. The antenna AN may be used to receive signals from e.g. satellites SA1, SA2 of the absolute positioning system.

It is observed that, the connections between different hardware elements may be physical connections, but one or more of these connections can be made wireless.

The positioning device PD may be a computer system, but can be any signal processing system with analog and/or digital and/or software technology arranged to perform the functions discussed here.

Absolute Positioning System

It will be understood that the embodiments described here, are not restricted to usage in combination with GPS-systems. The embodiments described may be used in combination with any kind of absolute positioning system using signals being sent wirelessly from a transmitter to a receiver, such as a positioning device PD, enabling the receiver to compute its position based on the received signals.

The absolute positioning system may be any kind of satellite based positioning system or global navigation satellite system (GNSS), such as the GPS-system, the European Galileo system, the Russian GLONASS, the Japanese QSSZ and the Chinese BNS.

The absolute positioning system may also be a terrestrial positioning system, using beacons positioned on land or sea that may be used to determine a position.

In general the absolute positioning system comprises a plurality of transmitters, such as satellites or beacons, arranged to wirelessly transmit signals, such as radio signals, that may be received by a receiver, such as a positioning device PD that is arranged to compute its position based on the received signals.

The absolute positioning system may also use signal strength of one or more broadcast stations, such as GSM-mast or digital television to determine its position.

According to an alternative, the position is determined by using information of the carrier wave used to modulate and form the radio signals described above. According to such an alternative, not the information that is transmitted using the carrier wave is used, but the carrier wave itself is used to determine position. This is referred to as carrier phase measurement and is known to a skilled person. Since the modulated information in not used, it is difficult to distinguish between different radio signals and determine which radio signal was sent by which transmitter. However, once that is known, a position can be determined.

In on the fly carrier phase measurement with the receiver in motion, a signal blockage may lead to a cycle slip. This is a discontinuity of an integer number of cycles in the measured (integrated) carrier phase. It may corrupt the carrier phase measurement, causing the unknown ambiguity value to be different after the cycle slip compared with its value before the slip. The ambiguity, which is different for each satellite-receiver pair, reflects the initial number of whole (integer) wavelengths in the receiver-satellite distance. Cycle slip repair restores the continuity of carrier cycle counts and ensures that there is only one ambiguity for each satellite-receiver pair. In real time and dynamic conditions, the pre knowledge of foreseeable signal blocking may help to mitigate the effect of cycle slips.

Digital Map Database

Digital map databases DMD, also known as geospatial databases or electronic maps, are known in the prior art. Digital map databases DMD in common usage today comprise information related to geographic location(s) and possibly incorporate some form of geographically related information, such as points of interest (e.g. museum, restaurant). In this application, the term digital map database DMD is used to denote all kinds of electronic and digital maps.

Digital map databases DMD may comprise a set of geospatial points and a set of vectors, representing (parts of) roads, connecting geospatial points. The digital map database DMD may further comprise additional information, for instance relating to the type of road (highway, foot path), maximum allowable speed (50 km/h, 100 km/h), street names, the presences of objects, such as tunnels and underground parkings, vehicle lane information (for example, number of lanes, lane width, lane divider type, stop line markings), etc. The digital map database DMD may further comprise information about type of environment (urban, rural, forest, agriculture) and the like.

The digital map database DMD may be used to compute navigation instructions to guide a user to a destination, as mentioned above. Depending on the current position of the user as determined by the positioning device, a part of the digital map database DMD may be displayed on a display.

Also, 3D digital map databases 3DMD may be provided further comprising three dimensional information, for instance about objects such as buildings, trees, rocks, mountains, roads, sidewalks, etc.

Such a 3D digital map database 3DMD may comprise information about the position of buildings, including the horizontal and vertical dimensions of such buildings. The 3D digital map database 3DMD may also comprise information about the shape of a building, which may for instance be relevant in case the building has a gabled roof (peaked roof).

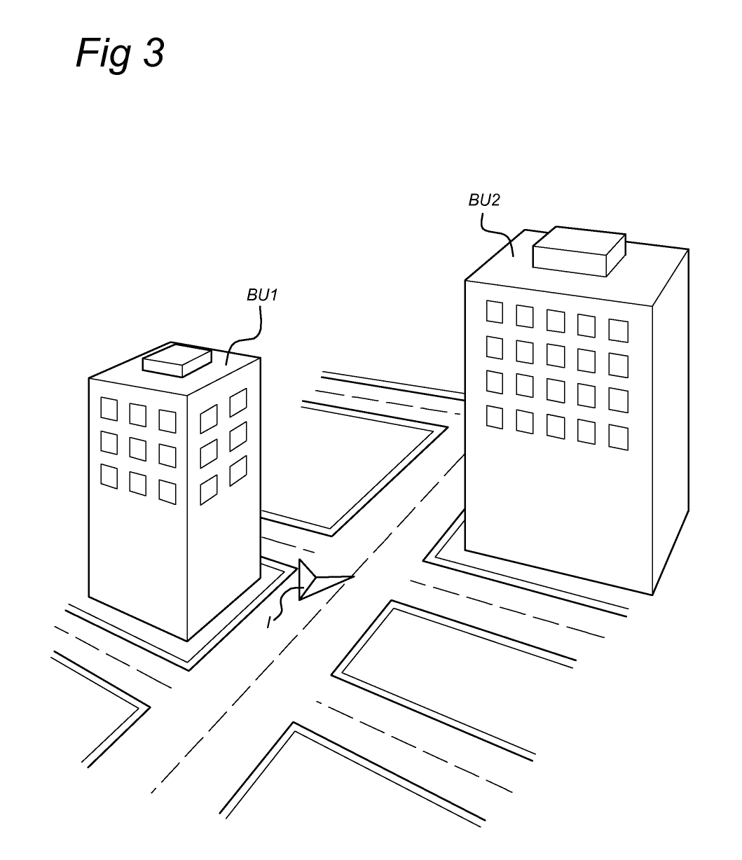

FIG. 3 schematically depicts such a 3D digital map database 3DMD as may be shown by a positioning device PD on a display. The figure depicts roads and buildings, and an indicator I indicating the position of the positioning device PD as determined by the positioning device PD.

The 3D digital map database 3DMD may comprise an accurate description of, for example, roof types of buildings, reflective properties of building facades, presence power lines and vegetation. The positioning algorithms used inside the positioning device PD may be arranged to take this 3D digital map data into account in real time.

The digital map database DMD (not necessarily being a three dimensional digital map database 3DMD) may also comprise additional information, for instance assessments of tree coverage and average heights of buildings. This will further be explained below.

### EMBODIMENT 1

According to an embodiment, the positioning device PD has access to a three dimensional (3D) digital map database 3DMD, as explained above.

According to an embodiment, the 3D digital map database 3DMD is stored in the memory ME.

According an alternative embodiment, the positioning device PD has access to a 3D digital map database 3DMD via a reading device, arranged to read data carriers, such as for instance floppy disks, CD ROM's, DVD's FLASH cards, USB-sticks and the like.

According to an alternative embodiment, the positioning device PD has access to a 3D digital map database 3DMD via a communication device as described above, allowing the positioning device PD to access a remote 3D digital map database 3DMD via a communication link, such as via a mobile telephone network, a GSM-network, a UMTS-network, a RF-network, (wireless) Internet etc.

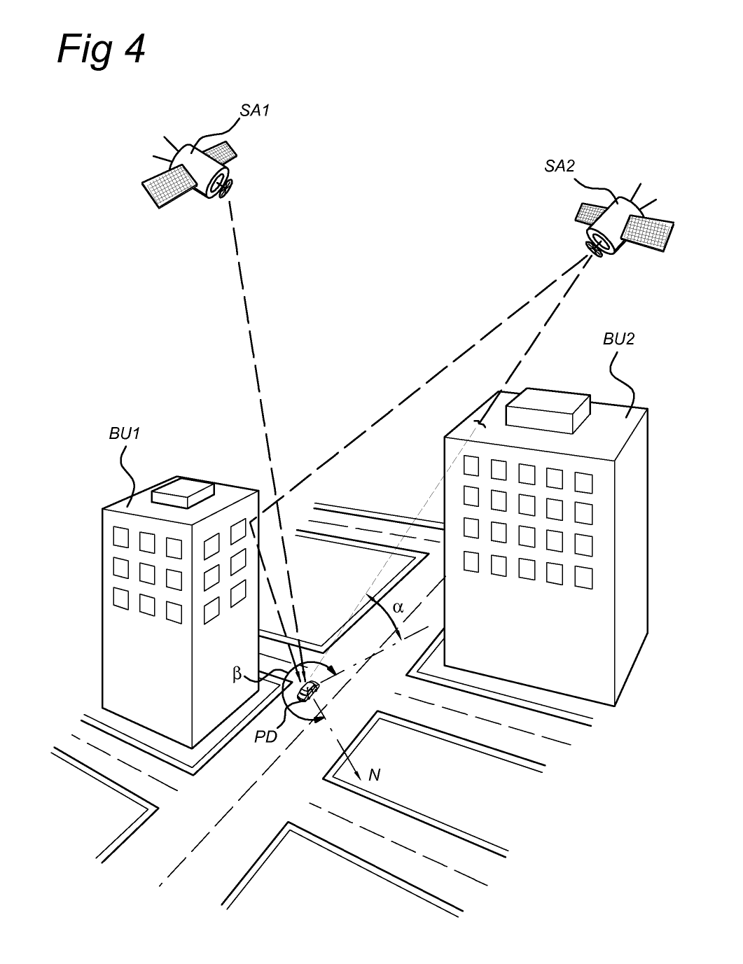

FIG. 4 schematically depicts the actual situation, again showing the roads and buildings, and the position of the positioning device PD. Further shown are the first and second satellites SA1, SA2. FIG. 4 also shows that the positioning device PD only sees part of the sky, as its ‘sight’ is partially blocked by the first and second buildings BU1, BU2. The positioning device PD directly receives radio signals from the first satellite SA1, but does not directly receive radio signals from the second satellite SA2, only reflections.

According to an embodiment, the three dimensional information stored in the three dimensional digital map database 3DMD is used as multi path information that may be used by the processor unit PU to compute which part of the sky is visible and which part of the sky is not visible, i.e. blocked. Based on the result of this computation, radio signals from some satellites SA1, SA2 may be disregarded, as it can be assumed that, if radio signals are received from such a blocked satellite, these radio signals were not received directly, but indirectly, i.e. via reflections and the like.

Or, in other words, the processor unit PU computes which radio signals are received from a visible satellite, i.e. received directly. Only directly received signals are used to compute the position.

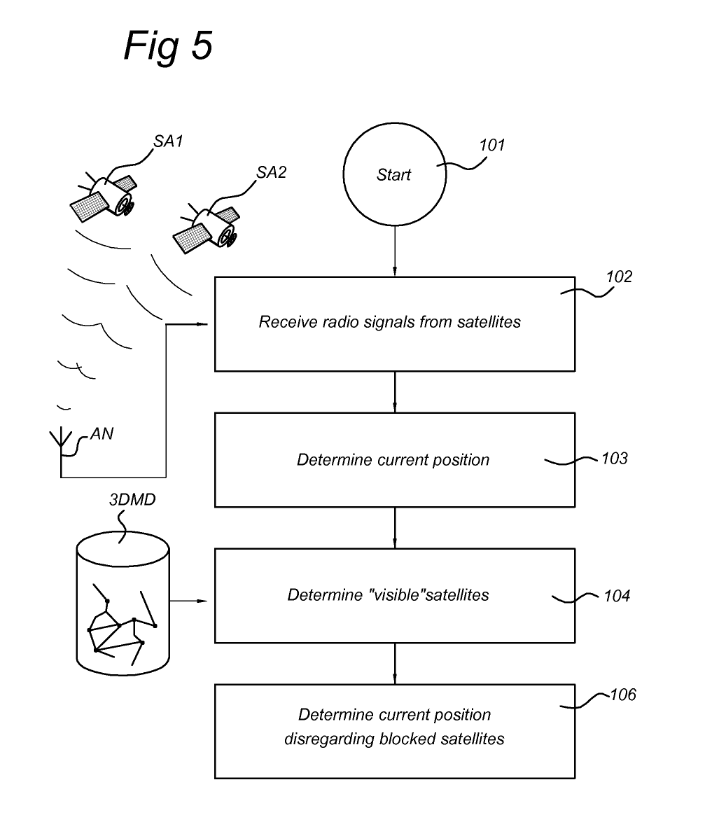

FIG. 5 schematically depicts a flow diagram as may be executed by a processor unit PU according to an embodiment of the invention.

In a first action 101, the positioning device PD is started to perform executing the process as described with reference to FIG. 5. This start action 101 may be initiated by a user or by switching on of the positioning device PD.

In a second action 102, positioning device PD receives radio signals from a plurality of satellites SA1, SA2 via antenna AN. It will be understood that although only two satellites SA1, SA2 are depicted, in fact radio signals may be received from many more satellites, e.g. up to 20 satellites. In fact, the radio signals may be received constantly and stored in a buffer memory, from which the positioning device PD reads out information from time to time, for instance when performing action 102.

In a next action 103, the positioning device PD may determine the current position of the positioning device PD based on the received radio signals. It will be understood that all radio signals received may be taken into account at this point, as the current position of the positioning device PD is not yet known. The computed position may be in error based on using radio signals from satellites that have been distorted by multi path.

Alternatively, a first estimation of a position of the position device may be obtained from another positioning source, via an input device, such as via a wireless link with another service providing positioning which may use signal strength of one or more different broadcast stations (GSM, digital TV, etc.), or any combination of these technologies.

As explained above, when determining the position of the positioning device PD, orbital information from the satellites SA1, SA2 is used to determine the position of the satellites SA1, SA2. So, after action 103, the position of the satellites SA1, SA2 from which radio signals were received (via reflections or not) are known and may be stored by the positioning device PD.

After the current position is determined, in an action 104, the positioning device PD determines which satellites are visible (satellite SA1) and which satellites are not, i.e. from which satellites (satellite SA2) no direct radio signal can be received by the positioning device PD because direct communication from the satellite to the positioning device PD is blocked by an object, such as second building BU2. The positioning device PD uses the position information of the satellites (SA1, SA2) as received with the radio signals and the multi path information stored in the 3 dimensional digital map database 3DMD in combination with a previous determined position (in previous action 103). This action 104 is explained in more detail below.

According to an alternative, actions 104 and 106 may form an iterative process. A first position is determined in action 103 and a number of satellites are disregarded in action 104. After this, the positioning device PD proceeds with action 106 to compute the position again uses only the satellites that are not disregarded. After this, the positioning device PD returns to action 104 and selects again which satellites are to be disregarded, followed by action 106, etc.

The first time action 104 is performed a conservative margin may be used, so only satellites are used of which is it sure that they do not suffer from multi path. The margin may for instance be an angle of 5°, ensuring that a clearance of 5° is provided between the line of sight of the positioning device PD and the satellite with respect to the nearest object, such as a building. This margin takes into account the fact that the position of the positioning device PD is not yet known very accurately and/or the height of the buildings and the like is not known very accurately so it can not be computed with great accuracy which satellites are to be disregarded.

Actions 103 and 104 may be repeated in an iterative process, until the determined position of the positioning device PD does not change much anymore in between successive iterations.

The margin may be expressed in an angle, but may of course also be expressed in another way. The margin may also be expressed by artificially increasing the dimensions of objects such as buildings with a predetermined length, such as 5 metres. During the iterative process the margin may be decreased, as accuracies increase during the iterative process.

Of course, the flow diagram as described may take into account the number of available satellites. In case radio signals are received from a small number of satellites (such as four or five), actions 104 and 106 may be skipped. In such a case, disregarding satellites will have a negative effect on the accuracy, as too few satellites remain for (accurate) positioning.

In action 106, the positioning device PD may start to determine the position repeatedly, to provide up-to-date information about the position of the positioning device PD. Possibly, in between action 104 an 106 the positioning device PD may once more receive radio signals from the satellites SA1, SA2 via antenna AN similar to action 102.

In action 106, the positioning device PD may determine the current position while disregarding radio signals coming from satellites (satellite SA2) of which in action 104 was determined that no direct radio signals can be received.

After action 106, the positioning device PD may repeatedly determine the position of the positioning device PD. After action 106, the positioning device may for instance jump back to action 102.

Based on the explanation of FIG. 5 it will be understood that according to an embodiment, the position of the positioning device PD is determined only using radio signals from satellites of which radio signals can be received directly i.e. that are not blocked by objects, such as buildings and hence are subject to multi path. This can be computed based on 3D digital map data 3DMD, that is used as multi path information. It can also be understood that disregarding satellites is only possible, when the positioning device PD knows its position from a previous position determination. Therefore, the positioning device PD can not disregard satellites when determining its position for the first time. However, after the position is determined for the first time, it is possible to disregard satellites for a next position determination.

When assessing which satellites are to be disregarded, the next position of the positioning device PD may be predicted based on current velocity and heading, possibly using a predictive filter or a Relative Positioning System (RPS). An RPS can be a dead reckoning system (distance and heading sensors) or an INS (Inertial Navigation System) (gyroscope and accelerometers) or a combination thereof. Also, in case the positioning device PD is used to guide the positioning device PD along a predetermined route, information of this route can be used to predict a next position.

When determining its position for the first time, the positioning device PD does not disregard satellites, so the first position determination may be erroneous as a result of multi-path distortion. Based on this first erroneous position determination, it may be possible that the positioning device PD disregards wrong satellites. However, when the positioning device PD is in use and moving this error will disappear once a correct position determination has been done, for instance on a position where no multi path distortion is present.

Determining Visible and Blocked Satellites

As described above, in action 104 the positioning device PD determines which satellites SA1, SA2 are visible and which satellites are not. The positioning device PD can compute whether a satellite is visible or not, this using information about:

a) position of positioning device PD,

b) position of the respective satellite, and

c) multi path information, such as 3D digital map database 3DMD.

The position of the positioning device PD used for computing which satellites are visible and which are not is the most recent position determined by the positioning device PD, for instance in a previous position determination or a predicted position. If no recent position is known, no satellites can be disregarded according to procedure described with reference to FIG. 5.

The position of the respective satellite SA1, SA2 can be computed based on the orbital information as received from the respective satellite SA1, SA2. Using this information, an elevation angle α can be computed, which indicates under which angle the respective satellite SA1, SA2 can be seen with respect to the horizontal. It can also be determined in which direction β (β: direction angle) the respective satellite SA1, SA2 can be seen, for instance in a westerly direction (270° with respect to the northern direction). Both angles are indicated in FIG. 4 with respect to satellite SA2.

The multi path information comprised in the 3D digital map database 3DMD is taken from a memory ME, data carrier etc. as described above.

All this information can be used to compute whether or not direct communication between the positioning device PD and the satellite SA1, SA2 is possible using basic goniometric mathematics.

It will be understood that in case the positioning system is a terrestrial system, the positions of the transmitters is fixed and may be known by the positioning device PD. In that case, their positions only need to be determined once, and not repeatedly.

As described above, a margin may be used to ensure that direct receipt of radio signals is indeed possible, taking into account the inaccuracy of the position of the positioning device PD determined so far. The margin may also take into account inaccuracies on the (three dimensional) digital map database 3DMD, DMD. For instance, the height and width of objects may not be very accurate.

The margin may be expressed in an angle, ensuring the line of sight of the positioning device PD and the satellite for instance has a 5° clearance. The margin may also be provided by artificially increasing the height and/or width of the stored objects.

Relative positioning system

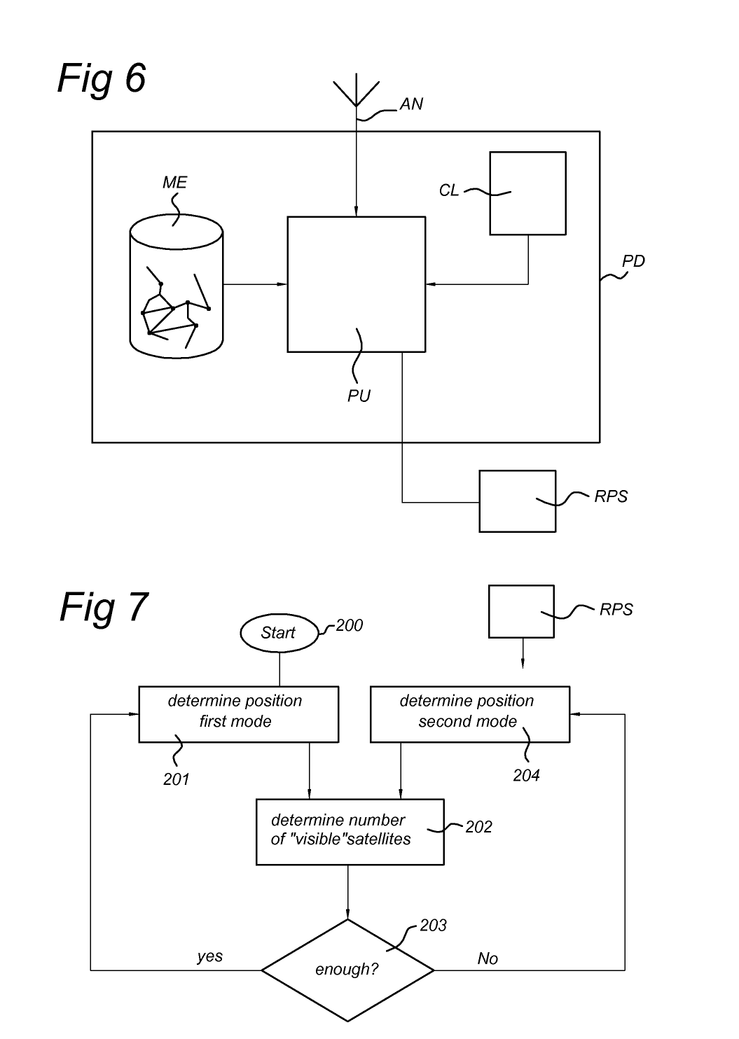

The positioning device PD may also comprise or interact with a Relative Positioning System RPS, as schematically depicted in FIG. 6. FIG. 6 schematically depicts a positioning device PD according to FIG. 2, further comprising a relative positioning system RPS that is arranged to provide information about relative movements to the processing unit PU.

Such a relative positioning system RPS may for instance be at least one of a gyroscope, an accelerometer, a compass. In case the positioning device PD is used in a vehicle, such as a car or motor cycle, the relative positioning system RPS may also be a velocity measurement module as usually present in such a vehicle and/or a module detecting steering actions of a steering wheel.

It will be understood that also other relative positioning systems RPS may be used. Also, a combination of different relative positioning systems RPS may be used.

For instance, the positioning device PD may be arranged to receive input from a velocity measurement module and a (n electronic) compass. Based on the input received from these modules, the processor unit PU of the positioning device PD may compute a relative position, as it is able to compute how far the positioning device PD has travelled in which direction.

According to the prior art, the positioning device PD may be arranged to switch from determining position based on the absolute positioning system to determining position based on relative positioning devices when no absolute position determination is possible, for instance when the positioning device PD enters a tunnel or underground parking From that moment, the positioning device PD uses relative positioning information provided by the relative positioning system RPS. The relative positioning information is used in combination with a recent absolute position as determined by the absolute positioning system to determine a current position.

Also, hybrid positioning is possible, in which the positioning device uses input from the absolute positioning system as well as the relative positioning system RPS.

According to an embodiment the position is determined by combined weighing of the absolute positioning system and the relative positioning system, where the weighing factors may be variables depending on the accuracy of the absolute positioning system and the relative positioning system. So, according to an embodiment, the positioning device PD is arranged to determine a position using an absolute positioning system and a relative positioning system. The positioning device may be arranged to work in a first mode, in which the position is determined using the absolute positioning system and possibly the relative positioning system, and in a second mode, in which the position is determined using the relative positioning system and possibly the absolute positioning system. In the first mode the absolute positioning system being weighted more heavily than in the second mode and the positioning device is arranged to switch from the first to the second mode.

### EMBODIMENT 2

According to a further embodiment, the positioning device PD comprises or interacts with a relative positioning system as described above. According to this embodiment, the positioning device PD is arranged to switch from the first mode to the second mode, as described above. Also, the positioning device PD may be arranged to switch from the second mode to the first mode.

According to this embodiment, the positioning device PD is arranged to switch from the first to the second mode when it determines that not enough satellites are visible, i.e. not enough signals can be received directly from satellites SA1, SA2 etc.

So, although enough signals are received, e.g. from seven different satellites SA1, SA2, the positioning device PD decides to switch from the first mode to the second mode as it is computed that only three satellites are visible and for the other four signals no direct receipt of signals is possible.

The positioning device PD may use a predetermined threshold to decide whether or not enough signals can be received directly. FIG. 7 schematically shows a flow diagram explaining the actions as may be taken by the processing unit PU.

In a first action 200, the positioning device PD may start executing the flow diagram as described here. The start may be triggered manually by a user or may for instance be triggered by switching on the positioning device PD.

In a second action 201, the positioning device PD determines its position in the first mode. In FIG. 3 the absolute positioning system is depicted by box APS. The absolute position may be determined according to the flow diagram of FIG. 5.

In an action 202, the positioning device PD determines how many satellites SA1, SA2 are visible, i.e. how many signals can be received directly.

In an action 203 the positioning device PD decides if enough satellites are visible. This may be done by comparing the determined number of visible satellites with a predetermined threshold, for instance 5 satellites. If enough satellites are visible, the positioning device PD returns to action 201. If not enough satellites are visible, the positioning device PD proceeds with an action 204.

As can be seen in FIG. 7, after action 201 and 204, action 202 and 203 are executed. This ensures that the positioning device PD automatically switches from the first mode to the second mode and vice versa when necessary and possible.

According to this embodiment, the positioning automatically switches from first mode to second mode, and vice versa. This embodiment provides an improvement of the overall positioning. So, by using the multi path information provided, an overall improvement of the positioning accuracy can be achieved.

### EMBODIMENT 3

The embodiments above describe the use of multi path information such as buildings and trees stored in a three dimensional digital map database 3DMD. However, also other multi path information may be provided.

According to an embodiment a two dimensional digital map database DMD may be provided comprising multi path information which describes the blocked sky view around a specific location. The multi path information may be provided by typifying areas or road segments with multi path information about possible multi path problems or blocked signals specific for that area or along that road segment.

This multi path information may include assessments of tree coverage and average heights of buildings. It may comprise a set of elevation angles α′, direction angles β′ and distances corresponding to objects blocking sight. The angles may be used by the positioning device PD to perform the embodiments described above. Also, an elevation angle α′ may be provided for a certain road or part of a road, where it is assumed that the corresponding direction angle β′ is substantially perpendicular to the road.

It will be understood that the elevation angle α′ and the direction angle β′ associated with the multi path information may simply be compared to the elevation angle α and the direction angle β associated with the respective satellite SA1, SA2 to determine if the satellite SA1, SA2 is visible or blocked.

So, instead of storing the dimensions of buildings and objects from which multi path information can be computed, the digital map database DMD may comprise angle information that can be used as multi path information.

The digital map database DMD may also comprise multi path information about the height of buildings along the road and the location of the façade with respect to for instance the centreline of the road. In this way an accurate elevation angle α′ can be calculated given where the positioning device PD is in its distance from the centreline. This multi path information may also be referred to as open sky information or local horizon information.

Based on this embodiment, it will be understood that multi path information may also be comprised in a digital map database DMD not being a three dimensional digital map database DMD.

Therefore, according to an embodiment there is provided a digital map database not comprising full 3D information about buildings but providing multi path information being height and location information or angle information to allow the positioning device PD to compute if a satellite is being blocked from direct reception.

So, the digital map database DMD, for instance being a two dimensional map database, may comprise multi path information, which may be at least one of:
height, shape and/or orientation information of an object, and distance of that object with respect to the road,
one elevation angle α′ for certain location or road, indicating that above this value open sky conditions are met,
one or a set of elevation angles α′ and direction angles β′ for a certain location or road,
one or a set of elevation angles α′ and direction angles β′ for a certain location or road, for each pair including one or more specific properties of the object found at that orientation
combination of elevation angle α′ and direction angle β′ for a certain position,
tree coverage information.

It will be understood that trees do not really create a geometrical multi path condition, in a way that signals are received via the trees. However, the trees may block or attenuate the direct path, such that the direct path gets weaker, and other multi path signals start to effect the reception and create an error.

### EMBODIMENT 4

According to a further embodiment, the computation from which satellites SA1, SA2 direct receipt of signals is possible is not based on information from a digital map database DMD, 3DMD, but is based on multi path information that is determined on the fly (in real time), for instance by using a camera or a laser scanner. This embodiment may be used when no (three dimensional) digital map database (3)DMD is available in which multi path information is stored. This embodiment may also be used in addition to using multi path information from a (three dimensional) digital map database (3)DMD.

This embodiment takes into account static objects, such as buildings and the like, as well as dynamic and/or temporary objects, such as a truck that is positioned or moving nearby (e.g. in a traffic jam), blocking part of the sky nearby the positioning device PD. Also other dynamic objects can be taken into account, such as trees that cover more sky during spring and summer compared to fall and winter.

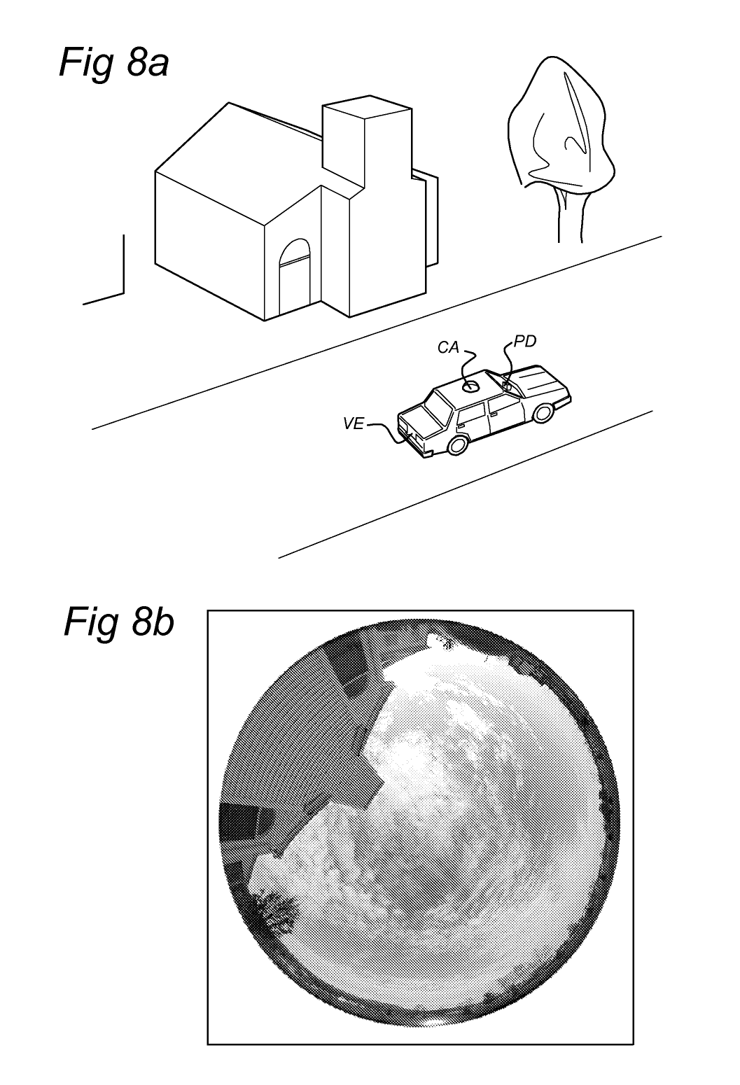

FIG. 8a shows an example of such an embodiment, depicting a car VE, comprising a positioning device PD and sensor for sensing objects, such as a (fisheye) camera CA, a laser scanner etc. In case the sensor is a fisheye camera CA, it may be positioned with its optical axis directed straight up (zenith), such that a surround view is captured. FIG. 8b shows an image as may be captured by the fisheye camera CA.

In case the sensor is a ‘normal’ camera, the camera may be mounted on an actuator that rotates the camera to obtain a surround view. Also, more than one camera may be provided.

The sensor may also be a laser scanner. A laser scanner may comprise a laser beam former mounted on an actuator. The laser scanner transmits a laser beam and the actuator is actuated in such a way that the laser beam scans its surroundings. Based on the received reflection, information is obtained about position, size and characteristics of objects. If no reflection is received, it is assumed that for that particular direction the sky is visible. The laser scanner may provide information about the angle of measurement and distance to nearest solid object that is visible at the particular angle

The laser scanner(s) may (for example) be arranged to produce an output with minimal 50 Hz and 1 deg resolution in order to produce a dense enough output.

The sensor may be connected to the positioning device PD to process the captured images. For instance, when the sensor is a (fisheye) camera, the positioning device PD may analyse the captured image and rely upon contrast differences, identified shape of objects (uninterrupted lines) etc. in the image to determine the contours of objects as buildings and trees.

The sensor may be positioned in the vicinity of the positioning device PD such that the visible sky of the sensor is substantially the same as the visible sky for the positioning device PD. Of course, the relative orientation of the sensor and the positioning device PD may be known to be able to deduce from the image captured by the sensor, the part of the sky that is visible for the positioning device PD.

In case the sensor and the positioning device PD are positioned at some distance from each other, the relative position (distance, heading) may be taken into account to deduce from the image captured by the sensor, the part of the sky that is visible for the positioning device PD. This may for instance be the case when the sensor is mounted on the roof of the car VE, as shown in FIG. 8a.

So, in this embodiment, a calibrated sensor, such as a laser scanner or (fisheye) camera, with known location and orientation with respect to the positioning device PD determines from distance measurements and/or lighting conditions which part of the sky is obstructed for direct reception of radio signals. One such example of a sensor system is an optical camera with fisheye lens mounted on top of a roof of a vehicle VE pointed to the sky.

### EMBODIMENT 5

Margin information may be used to ensure that direct receipt of radio signals is indeed possible, taking into account inaccuracies, such as inaccuracies in the position as determined by the positioning device PD, the height of the terrain etc. Margin information may also be provided to take into account inaccuracies in the (three dimensional) digital map database 3DMD, DMD. For instance, the dimensions (such as height and width) of objects may not be very accurate, which can be taken into account by assigning margin information to an object, such that a margin can be determined.

The margin may be expressed as an angle, ensuring the line of sight between the positioning device PD and a transmitter SA1, SA2 has e.g. a 5° clearance with objects. The margin may also be expressed as a dimension error Eh, for instance 3 meters or as a percentage of the height/width of an object (e.g. 4% of total height of a building).

The digital map database or 3D digital map database 3DMD may comprise margin information (e.g. expressed as an angle, percentage or dimension error Eh).

Margin information may be assigned to an individual object. Margin information may also be assigned to a group of objects. A group of objects may be defined by their type, such as block of flats, churches etc. Margin information may also be assigned to an object or group of objects based on the process which was used to create the objects in the digital map database DMD or 3D digital map database 3DMD, for instance the use of aerial photograph stereo pairs, lidar/ifsar data, with known (in)accuracy value.

Margin information may be assigned manually or may be assigned automatically based on type of object, process used to create the object etc.

The margin information may be used to compute a margin area in which transmitters SA1, SA2 may or may not be masked for a specific position V of the positioning device PD. Although the margin area is not necessarily completely blocked, it is considered to be blocked to make sure no multi path problems are present.

This margin area may be defined by an angle M. When computing such a margin area the distance d between the position V and the building SA3 needs to be taken into account.

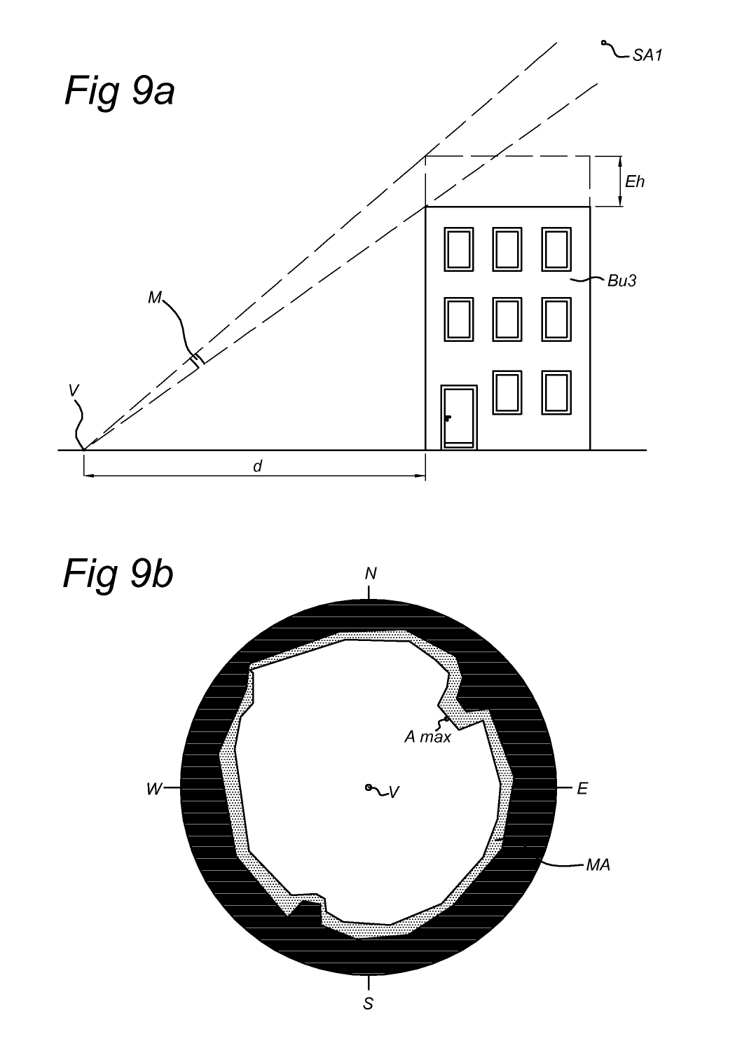

This is shown in FIG. 9a, showing position V, a building BU3, an dimension error Eh for the height of the building BU3 and an angle M for which it is uncertain if a direct line of sight between the positioning device PD and a transmitter SA1, SA2 is possible.

So, the margin information translates to an angle M defining the margin area for which transmitters SA1, SA2 may or may not be masked for a specific location V. This margin area MA can be represented in a sky plot figure, as shown in FIG. 9b: grey shade. The letters N, E, S, W refer to north, east, south and west respectively.

To simplify the computational processes, the sky plot may be simplified by only using the highest masking elevation (Amax in FIG. 9b) as relevant value for all directions.

Margin information may also be assigned to the road or terrain in case the exact height of the road or terrain is not known accurately or varies over short distances (rough terrain).

The above described margin information or other possibly simplified representations thereof (sky plots) may be stored in the digital map database DMD or 3D digital map database 3DMD.

So, according to an embodiment there is provided a method wherein margin information is used to compute from which transmitters SA1, SA2 direct receipt of signals possible. The margin information is used to ensure that a clearance is provided between the multi path information and the line of sight connecting the positioning device PD and the transmitter.

Thus, a method is provided comprising:
receiving signals from a plurality of transmitters, the transmitters being part of an absolute positioning system,
determining transmitter positions of each transmitter,
computing from which transmitters direct receipt of signals is possible based on a previously determined position, the respective transmitter positions, margin information and multi path information, and
determining a position.

According to a further embodiment, a positioning is provided, wherein margin information is used to compute from which transmitters SA1, SA2 direct receipt of signals possible. The margin information is used to ensure that a clearance is provided between the multi path information and the line of sight connecting the positioning device PD and the transmitter.

Furthermore there is provided a digital map database, comprising information related to geographic location(s) and objects, wherein the digital map database further comprises margin information, the margin information can be used to ensure that a clearance is provided between the multi path information and the line of sight connecting the positioning device PD and the transmitter.

In conclusion, margin information can be used to determine a margin (or clearance) between multi path information, such as buildings, and a line of sight connecting the positioning device PD and a transmitter. In case a line of sight of a specific transmitter is in the margin, the specific transmitter is not used when determining a position to reduce possible multi path problems.

### FURTHER REMARKS

The embodiment described above provides a way to improve satellite based positioning by eliminating bad satellite signals using multi path information (describing the open sky horizon) stored in a (three dimensional) digital map databases, a two dimensional digital map database or determined on the fly. The multi path information is information that can be used to determine which part of the sky is blocked by objects, such as buildings, and which part of the sky is visible. The multi path information may be stored in a three dimensional digital map database 3DMD, a digital map database DMD, or may be determined on the fly using an appropriate sensor.

By the knowledge of the approximate position of the antenna, for instance derived from a previous positioning determination, multi path information and information about the position of the satellites SA1, SA2 in space, it is possible to determine if a signal is received directly by calculation of the satellite elevation and direction angle. The multi path information allows intelligently eliminating radio signals in the calculation of the position. Also, it may be decided to apply a weighing factor to location information from satellites that are not directly received, as to reduce their influence on the position as determined or to decide to switch from a first mode to a second mode.

The embodiments described here will especially be useful in situations where many satellites SA1, SA2 are present. Navigation satellites will be abundant in future (European Galileo system, revived Russian GLONASS, Japanese QSSZ, Chinese BNS). Selecting the satellites from which direct signals can be received, as described here, will benefit positioning and in particular 3D positioning.

In the embodiments described above it is described that the positioning device PD may switch from first to second mode. Of course, also more than two modes may be defined, each mode having a different set of weighing factors of the absolute positioning device and the relative positioning device. Also, the weighing factors may be variables that are determined on the spot.

It will be understood that the embodiments as described here may be provided as a computer program that, when loaded on a computer arrangement, is arranged to perform any one of the embodiments described above. Such a computer program may be formed by a number of instructions that are readable and executable by the processor PU to perform at least one of the embodiments above. The computer program may be provided on a data carrier, such as a computer readable medium, e.g. a floppy disk, a memory card, a CD, a DVD, etc.

In this text the term multi path information is used to refer to all kind of information that may be used to compute from which transmitters direct receipt of signals is possible or not. The multi path information may be three dimensional information from which this can be deduced (indirect information) or may also be direct information obtained on the fly or may be angle information and the like, stored in the digital map database. So, all kind of information that may be used to compute from which transmitters direct receipt of signals is possible is referred to as multi path information

It will be understood that the above embodiments may also be used in combination with carrier phase measurement techniques to determine position. BY knowing which transmitters may suffer multi path problems, the problem of cycle slips may be anticipated.

For the purpose of teaching the invention, preferred embodiments of the method and devices of the invention were described. It will be apparent for the person skilled in the art that other alternative and equivalent embodiments of the invention can be conceived and reduced to practice without departing from the true spirit of the invention, the scope of the invention being only limited by the annexed claims.

1. Method for determining a position, the method comprising:
receiving signals from a plurality of transmitters, the plurality of transmitters being part of an absolute positioning system;
determining a transmitter positions for each of the plurality of transmitters,
computing from which of the plurality of transmitters direct receipt of signals is possible based on a previously determined position, the determined respective positions of the plurality of transmitters and multi path information; and
determining the position based on the signals received from the plurality of transmitters from which direct receipt was computed to be possible.

2. Method according to claim 1, wherein the transmitter positions are determined at least one of based on information comprised by the signals, and by retrieving transmitter positions from a memory.

3. Method according to claim 1, wherein the multi path information is stored in a digital map database.

4. Method according to claim 3, wherein the digital map database is a three dimensional digital map database.

5. Method according to claim 4, wherein the three dimensional map database comprises multi path information in the form of three dimensional objects.

6. Method according to claim 3, wherein multi path information is provided by one of:
height information of an object, and distance of the object with respect to a road,
elevation angle for a certain location or road,
a combination of elevation angle and direction angle for a position,
environmental factors, or
a set of elevation angles and direction angles, or heights of buildings along the road and the location of a facade with respect to the road.

7. Method according to claim 1, wherein the multi path information is determined on the fly using a sensor.

8. Method according to claim 7, wherein the sensor includes one of a camera, fisheye camera, and laser scanner.

9. Method according to claim 1, wherein the previously determined position is a predicted position.

10. Method according to claim 1, wherein the previously determined position is obtained from another positioning source.

11. Method according to claim 1, further comprising:
computing the position based on the signals received from the plurality of transmitters of which direct receipt is possible.

12. Method according to claim 11, wherein the computing from which of the plurality of transmitters direct receipt of signals is possible based on a previously determined position, the respective transmitter positions and multi path information, and the determining of the position based on the signals received from the plurality of transmitters of which direct receipt is possible, are repeatedly performed in an iterative process to determine the position.

13. Method according to claim 1, wherein the position is determined in at least one of:
a first mode, in which the position is determined using the absolute positioning system and at least one of with and with a relative positioning system, and
a second mode, in which the position is determined using the relative positioning system and at least one of with and without the absolute positioning system, and in the first mode the absolute positioning system being weighted relatively more heavily than in the second mode, the method further comprising
determining the number of the plurality of transmitters from which direct receipt of signals is possible and
switching from first mode to the second mode upon the determined number of the plurality of transmitters is below a threshold.

14. Method according to claim 13, further comprising:
switching from the second mode to the first mode upon the number of transmitters being above a threshold.

15. Method according to claim 1, wherein the position is determined by weighed combination of an the absolute positioning system and a relative positioning system using weighing factors, the method further comprising:
determining the number of the plurality of transmitters from which direct receipt of signals is possible and adjusting the weighing factors based on the number of the plurality of transmitters from which direct receipt of signals is possible.

16. Method according to claim 1, wherein computing from which of the plurality of transmitters direct receipt of signals is possible comprises at least one of:
using the multi path information to determine an elevation angle and a direction of each respective of the plurality of transmitter with respect to the previously determined position; and
computing if a line connecting a position device and a respective one of the plurality of transmitters intersects an obstruction comprised by the multi path information.

17.-18. (canceled)

19. Method according to claim 16, wherein margin information is used at least one of to compute from which of the plurality of transmitters direct receipt of signals is possible, and to ensure that a clearance is provided between the multi path information and a line of sight connecting the positioning device and the transmitter.

20. (canceled)

21. Positioning device comprising:
a receiving device to receive signals from a plurality of transmitters, the transmitters being part of an absolute positioning system, the positioning device being arranged to determine transmitter positions of each of the plurality of transmitters and to compute from which of the plurality of transmitters direct receipt of signals is possible based on a previously determined position, the respective positions of each of the plurality of transmitters and multi path information, the positioning device being further arranged to determine a position based on the signals received from the plurality of transmitters from which direct receipt was computed to be possible.

22.-41. (canceled)

42. Computer program, when loaded on and executed on a computer arrangement, arranged to perform the methods according to claim 1.

43.-46. (canceled)

47. Data carrier comprising the computer program of claim 42.
